(19) United States
(12) Patent Application Publication
(10) Pub. No.: US 2026/0247358 A1
(43) Pub. Date: Aug. 20, 2026

(54) TARGET BEAM IDENTIFICATION FOR TEMPORAL BEAM PREDICTION

(71) Applicant: QUALCOMM Incorporated, San Diego, CA (US)

(72) Inventors: Qiaoyu LI, Beijing (CN); Jelena DAMNJANOVIC, Del Mar, CA (US); Mahmoud TAHERZADEH BOROUJENI, San Diego, CA (US)

(21) Appl. No.: 19/489,577

(22) PCT Filed: Jun. 7, 2023
(86) PCT No.: PCT/CN2023/098805

§ 371 Date: Dec. 2, 2025

(51) Int. Cl. H04W 72/0446; H04B 7/06; H04B 17/318; H04W 72/232

(52) U.S. Cl. CPC H04W 72/0446; H04B 7/0626; H04B 17/328; H04W 72/232

(57) ABSTRACT

Certain aspects of the present disclosure provide techniques for target beam identification for temporal beam prediction. An example method, performed at a user equipment (UE), includes receiving configuration information configuring the UE with at least one first set of resources for channel prediction and at least one second set of resources for channel measurement, wherein the first and second sets of resources comprise resources associated with different candidate cells, receiving signaling indicating target prediction resources comprising a subset of the first set of resources, predicting channel characteristics associated with one or more time domain (TD) occasions of one or more of the target prediction resources, based on measurement of reference signals (RSs) transmitted on resources of the second set, and transmitting a report indicating the predicted channel characteristics.

### BACKGROUND

### Field of the Disclosure

Aspects of the present disclosure relate to wireless communications, and more particularly, to techniques for temporal beam prediction.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication at a user equipment (UE). The method includes receiving configuration information configuring the UE with at least one first set of resources for channel prediction and at least one second set of resources for channel measurement, wherein the first and second sets of resources comprise resources associated with different candidate cells; receiving signaling indicating target prediction resources comprising a subset of the first set of resources; predicting channel characteristics associated with one or more time domain (TD) occasions of one or more of the target prediction resources, based on measurement of reference signals (RSs) transmitted on resources of the second set; and transmitting a report indicating the predicted channel characteristics.

Another aspect provides a method for wireless communication at a network entity. The method includes transmitting configuration information configuring a user equipment (UE) with at least one first set of resources for channel prediction and at least one second set of resources for channel measurement, wherein the first and second sets of resources comprise resources associated with different candidate cells; transmitting signaling indicating target prediction resources comprising a subset of the first set of resources; transmitting reference signals (RSs) on resources of the second set; and receiving a report indicating predicted channel characteristics associated with one or more time domain (TD) occasions of one or more of the target prediction resources, based on measurement of the RSs.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates example beam refinement procedures, in accordance with certain aspects of the present disclosure.

FIG. 6 is a diagram illustrating example operations where beam management may be performed.

FIG. 7 illustrates a general functional framework applied for AI-enabled RAN intelligence.

FIG. 8 depicts an example two-part uplink control information (UCI).

FIG. 9 depicts example artificial intelligence (AI)/machine learning (ML)-based layer 1/2(L1 /L2)-triggered mobility (LTM).

FIG. 10 depicts an example scenario involving time domain (TD) beam prediction for LTM.

FIG. 11 depicts a call flow diagram, in accordance with certain aspects of the present disclosure.

FIG. 12 depicts an example of target beam identification for temporal beam prediction, in accordance with certain aspects of the present disclosure.

FIG. 13 depicts an example of target beam identification for temporal beam prediction, in accordance with certain aspects of the present disclosure.

FIG. 14 depicts an example of target beam identification for temporal beam prediction, in accordance with certain aspects of the present disclosure.

FIG. 15 depicts a method for wireless communications.

FIG. 16 depicts a method for wireless communications.

FIG. 17 depicts aspects of an example communications device.

### DETAILED DESCRIPTION

Aspects of the present disclosure provide apparatuses, methods, processing systems, and computer-readable mediums for target beam identification for temporal beam prediction.

In advanced wireless systems, mobility procedures are in place to help maintain network connections for a user equipment (UE) as it moves between the coverage areas of different cells. Mobility procedures generally refer to mechanisms that allow a UE to transition from being served by a source cell to being served by a target cell. In some cases, for physical layer (PHY or Layer 1/L1) and/or medium access control layer (MAC or Layer 2/L2), also referred to as L1/L2 triggered mobility (LTM), as a UE moves, a new serving cell (e.g. a primary cell (Pcell)) may be selected (e.g., reselected) among a set of pre-configured candidate cells based on L1 measurement for those cells.

Temporal beam prediction, also known as time-domain (TD) beam prediction, generally refers to a technique used in wireless communications to anticipate and optimize the direction of transmission and/or reception beams over time. Temporal beam prediction may involve predicting a beam that will be suitable (preferred) for use in the future. The prediction may be based on current measurements of reference signals sent using different beams (which may or may not include the predicted beam). Temporal beam prediction may be particularly relevant in scenarios where the wireless channel conditions change rapidly, such as in high-mobility environments or in the presence of fading effects.

In wireless communication systems that employ beamforming, multiple antennas may be used to transmit and receive signals. By dynamically adjusting the direction of the transmit beam, the transmitted energy may be focused towards the intended receiver, which may mitigate interference from other directions. However, due to the dynamic nature of wireless channels, the optimal beam direction can change rapidly, leading to suboptimal performance if the beamforming strategy is not continuously and effectively updated.

Temporal beam prediction addresses this challenge by utilizing historical channel state information (CSI) and exploiting temporal correlations in the wireless channel. By analyzing past channel measurements, such as received signal strength, signal quality, and/or channel characteristics, it is possible to infer the future behavior of the wireless channel and predict the optimal beam direction.

In LTM, for example, a network entity (e.g., a gNB) may be able to predict which (e.g., 1 or 2) candidate cells (e.g., among candidate cells measured by a UE) have higher probability to be switched to in upcoming duration. However, delays of non-ideal backhaul may be tens of milliseconds. Thus, prediction of beams and corresponding transmission configuration indicator (TCI) states in target candidate cells ahead of cell-switching may be advantageous.

On the other hand, due to restrictions/limitations of uplink control information (UCI) payload size, it may be advantageous to limit the UCI reporting of predictions for target beams to a limited amount in TD beam prediction (e.g., where the UE reports predicted channel characteristics regarding future occasions about candidate beams in candidate cells). When the number of candidate beams increases, the overhead to indicate their respective beam-IDs may become excessively large.

Aspects of the present disclosure provide techniques for a network entity to indicate (e.g., and dynamically update/adjust) target beams in target cells for prediction regarding future TD occasions. For example, a network entity may indicate future candidate cells/beams (e.g., target prediction resources) and transmit reference signals (RSs) to a UE, allowing the UE to predict channel characteristics associated with TD occasions of the target prediction resources based on measurement of the RSs, and report the predicted channel characteristics to the network. Utilization of the techniques disclosed herein may improve spectral efficiency, reduce interference, and enhance overall system performance, especially in dynamic environments where the wireless channel changes rapidly. These techniques may enable more robust and reliable communication links, even in challenging conditions, leading to better quality of service and user experience.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

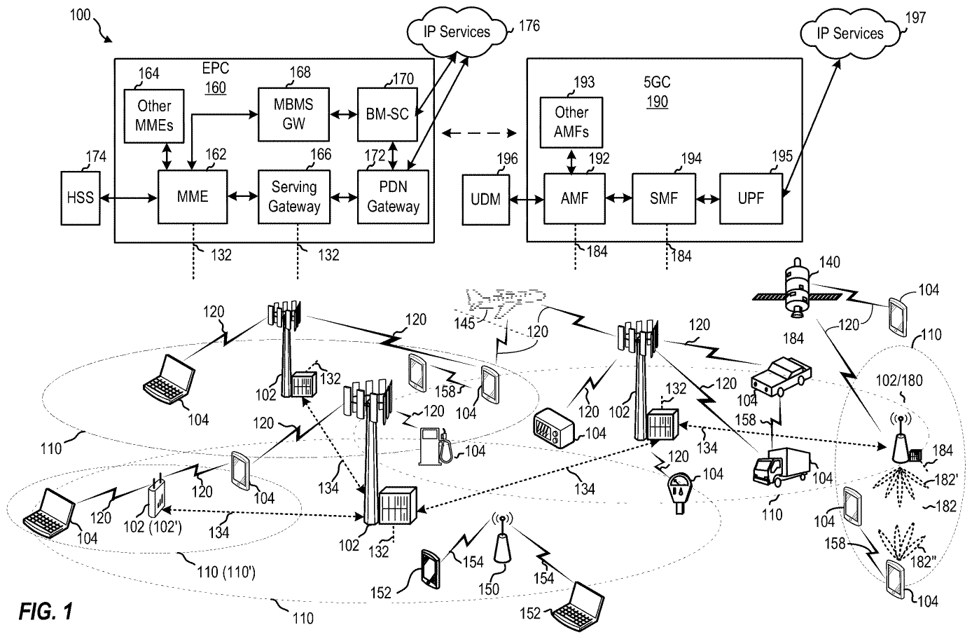

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

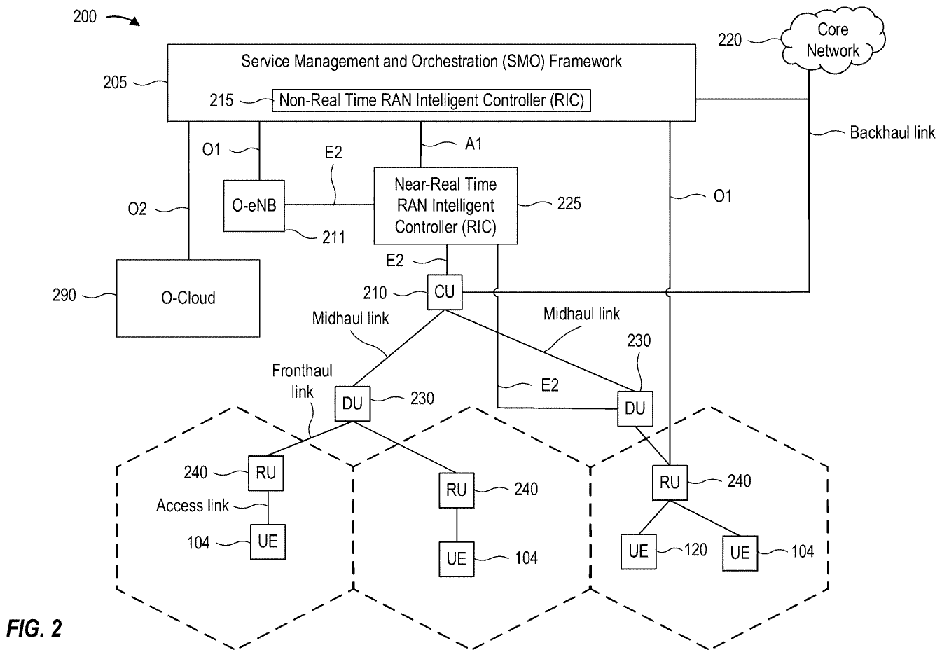

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR 1) as including 410 MHz-7125 MHz, which is often referred to (interchangeably) as “Sub-6 GHz”. Similarly, 3GPP currently defines Frequency Range 2 (FR 2) as including 24,250 MHz-52,600 MHZ, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the El interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an Ol interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as Al policies).

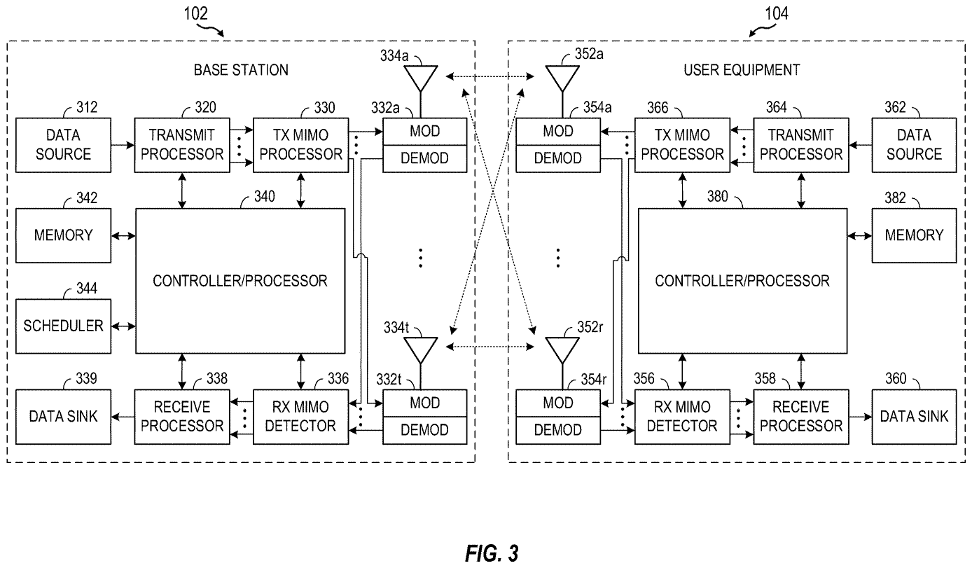

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

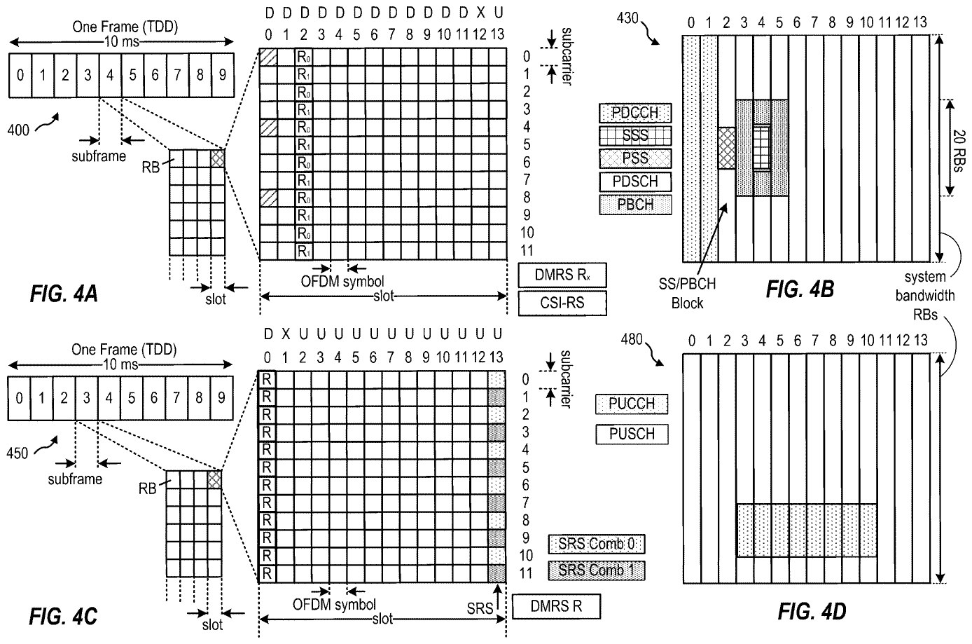

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCHI) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Beam Refinement Procedures

In mm Wave systems, beam forming may be important to overcome high path-losses. As described herein, beamforming may refer to establishing a link between a BS and UE, wherein both of the devices form a beam corresponding to each other. Both the BS and the UE find at least one adequate beam to form a communication link. BS-beam and UE-beam form what is known as a beam pair link (BPL). As an example, on the DL, a BS may use a transmit beam and a UE may use a receive beam corresponding to the transmit beam to receive the transmission. The combination of a transmit beam and corresponding receive beam may be a BPL.

As a part of beam management, beams which are used by BS and UE have to be refined from time to time because of changing channel conditions, for example, due to movement of the UE or other objects. Additionally, the performance of a BPL may be subject to fading due to Doppler spread. Because of changing channel conditions over time, the BPL should be periodically updated or refined. Accordingly, it may be beneficial if the BS and the UE monitor beams and new BPLs.

At least one BPL has to be established for network access. As described above, new BPLs may need to be discovered later for different purposes. The network may decide to use different BPLs for different channels, or for communicating with different BSs (TRPs) or as fallback BPLs in case an existing BPL fails.

The UE typically monitors the quality of a BPL and the network may refine a BPL from time to time.

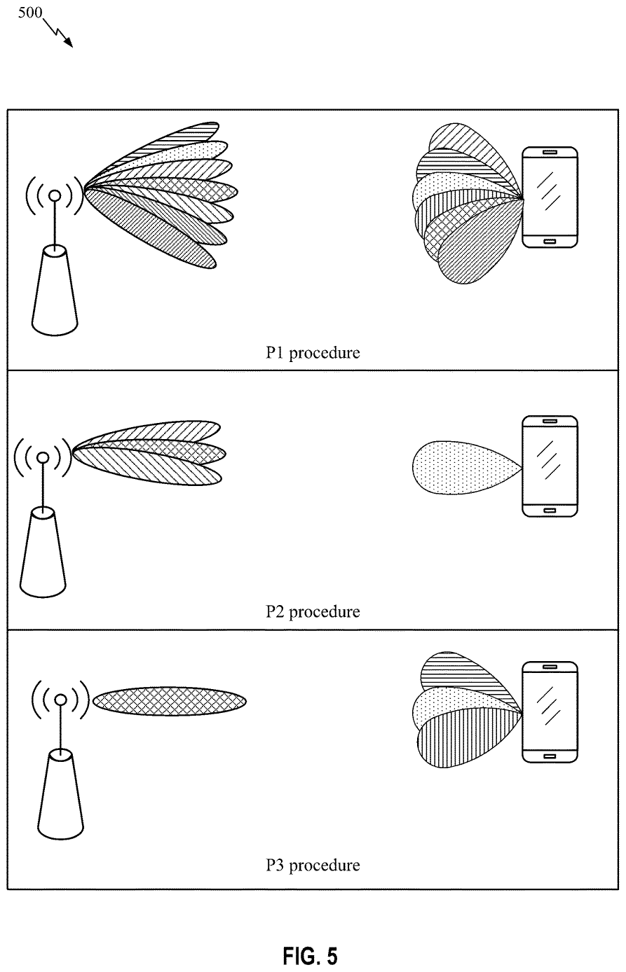

FIG. 5 illustrates example 500 for BPL discovery and refinement. In 5G-NR, the P1, P2, and P3 procedures are used for BPL discovery and refinement. The network uses a P1 procedure to enable the discovery of new BPLs. In the P1 procedure, as illustrated in FIG. 5, the BS transmits different symbols of a reference signal, each beam formed in a different spatial direction such that several (e.g., most or all) relevant places of the cell are reached. Stated otherwise, the BS transmits beams using different transmit beams over time in different directions.

For successful reception of at least a symbol of this “P1-signal”, the UE has to find an appropriate receive beam. It searches using available receive beams and applying a different UE-beam during each occurrence of the periodic P1-signal.

Once the UE has succeeded in receiving a symbol of the P1-signal it has discovered a BPL. The UE may not want to wait until it has found the best UE receive beam, since this may delay further actions. The UE may measure the reference signal receive power (RSRP) and report the symbol index together with the RSRP to the BS. Such a report will typically contain the findings of one or more BPLs.

In an example, the UE may determine a received signal having a high RSRP. The UE may not know which beam the BS used to transmit; however, the UE may report to the BS the time at which it observed the signal having a high RSRP. The BS may receive this report and may determine which BS beam the BS used at the given time.

The BS may then offer P2 and P3 procedures to refine an individual BPL. The P2 procedure refines the BS-beam of a BPL. For example, the BS may transmit a few symbols of a reference signal with different BS-beams that are spatially close to the BS-beam of the BPL (the BS performs a sweep using neighboring beams around the selected beam). In P2, the UE keeps its beam constant. Thus, while the UE uses the same beam as in the BPL (as illustrated in P2 procedure in FIG. 5). The BS-beams used for P2 may be different from those for P1 in that they may be spaced closer together or they may be more focused. The UE may measure the RSRP for the various BS-beams and indicate the best one to the BS.

The P3 procedure refines the UE-beam of a BPL (see P3 procedure in FIG. 5). While the BS-beam stays constant, the UE scans using different receive beams (the UE performs a sweep using neighboring beams). The UE may measure the RSRP of each beam and identify the best UE-beam. Afterwards, the UE may use the best UE-beam for the BPL and report the RSRP to the BS.

Over time, the BS and UE establish several BPLs. When the BS transmits a certain channel or signal, it lets the UE know which BPL will be involved, such that the UE may tune in the direction of the correct UE receive beam before the signal starts. In this manner, every sample of that signal or channel may be received by the UE using the correct receive beam. In an example, the BS may indicate for a scheduled signal (e.g., SRS, CSI-RS) or channel (e.g., PDSCH, PDCCH, PUSCH, PUCCH) which BPL is involved. In NR, this information may be referred to as a quasi co-location (QCL) indication.

Two antenna ports are quasi co-located (QCL) if properties of the channel over which a symbol on one antenna port is conveyed may be inferred from the channel over which a symbol on the other antenna port is conveyed. QCL supports, at least, beam management functionality, frequency/timing offset estimation functionality, and radio resource management (RRM) functionality.

The BS may use a BPL which the UE has received in the past. The transmit beam for the signal to be transmitted and the previously-received signal both point in a same direction or are QCL. The QCL indication may be needed by the UE (in advance of signal to be received) such that the UE may use a correct receive beam for each signal or channel. Some QCL indications may be needed from time to time when the BPL for a signal or channel changes and some QCL indications are needed for each scheduled instance. The QCL indication may be transmitted in the downlink control information (DCI), which may be part of the PDCCH channel. Because DCI is needed to control the information, it may be desirable that the number of bits needed to indicate the QCL is not too big. The QCL may be transmitted in a medium access control-control element (MAC-CE) or radio resource control (RRC) message.

According to one example, whenever the UE reports a BS beam that it has received with sufficient RSRP, and the BS decides to use this BPL in the future, the BS assigns it a BPL tag. Accordingly, two BPLs having different BS beams may be associated with different BPL tags. BPLs that are based on the same BS beams may be associated with the same BPL tag. Thus, according to this example, the tag is a function of the BS beam of the BPL.

As noted above, wireless systems, such as millimeter wave (mmW) systems, bring gigabit speeds to cellular networks, due to availability of large amounts of bandwidth. However, the unique challenges of heavy path-loss faced by such wireless systems necessitate new techniques such as hybrid beamforming (analog and digital), which are not present in 3G and 4G systems. Hybrid beamforming may enhance link budget/signal to noise ratio (SNR) that may be exploited during the RACH.

In such systems, the node B (NB) and the user equipment (UE) may communicate over active beam-formed transmission beams. Active beams may be considered paired transmission (Tx) and reception (Rx) beams between the NB and UE that carry data and control channels such as PDSCH, PDCCH, PUSCH, and PUCCH. As noted above, a transmit beam used by a NB and corresponding receive beam used by a UE for downlink transmissions may be referred to as a beam pair link (BPL). Similarly, a transmit beam used by a UE and corresponding receive beam used by a NB for uplink transmissions may also be referred to as a BPL.

Since the direction of a reference signal is unknown to the UE, the UE may evaluate several beams to obtain the best Rx beam for a given NB Tx beam. However, if the UE has to “sweep” through all of its Rx beams to perform the measurements (e.g., to determine the best Rx beam for a given NB Tx beam), the UE may incur significant delay in measurement and battery life impact. Moreover, having to sweep through all Rx beams is highly resource inefficient. Thus, aspects of the present disclosure provide techniques to assist a UE when performing measurements of serving cells and neighbor cells when using Rx beamforming.

### Example Beam Management

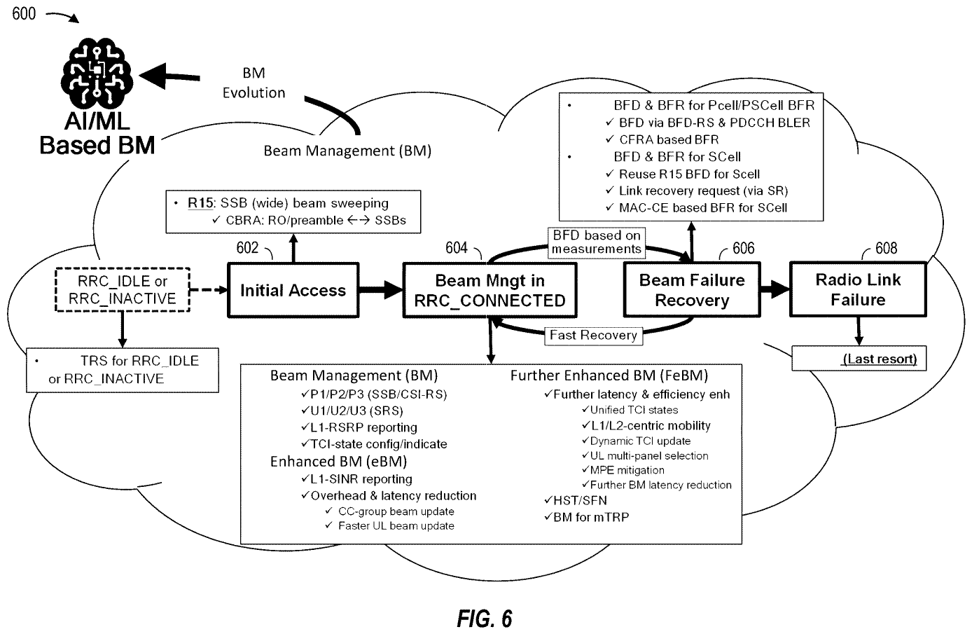

In wireless communications, various procedures may be performed for beam management. FIG. 6 is a diagram illustrating example operations where beam management may be performed. In initial access 602, the network may sweep through several beams, for example, via synchronization signal blocks (SSBs), as further described herein with respect to FIG. 4B. The network may configure the UE with random access channel (RACH) resources associated with the beamformed SSBs to facilitate the initial access via the RACH resources. In certain aspects, an SSB may have a wider beam shape compared to other reference signals, such as a channel state information reference signal (CSI-RS). A UE may use SSB detection to identify a RACH occasion (RO) for sending a RACH preamble (e.g., as part of a contention-based Random Access (CBRA) procedure).

In connected mode 604, the network and UE may perform hierarchical beam refinement including beam selection (e.g., a process referred to as P1), beam refinement for the transmitter (e.g., a process referred to as P2), and beam refinement for the receiver (e.g., a process referred to as P3). In beam selection (P1), the network may sweep through beams, and the UE may report the beam with the best channel properties, for example. In beam refinement for the transmitter (P2), the network may sweep through narrower beams, and the UE may report the beam with the best channel properties among the narrow beams. In beam refinement for the receiver (P3), the network may transmit using the same beam repeatedly, and the UE may refine spatial reception parameters (e.g., a spatial filter) for receiving signals from the network via the beam. In certain aspects, the network and UE may perform complementary procedures (e.g., U1, U2, and U3) for uplink beam management.

In certain cases where a beam failure occurs (e.g., due to beam misalignment and/or blockage), the UE may perform a beam failure recovery (BFR) procedure 606, which may allow a UE to return to connected mode 604 without performing a radio link failure procedure 608. For example, the UE may be configured with candidate beams for beam failure recovery. In response to detecting a beam failure, the UE may request the network to perform beam failure recovery via one of the candidate beams (e.g., one of the candidate beams with a reference signal received power (RSRP) above a certain threshold). In certain cases where radio link failure (RLF) occurs, the UE may perform an RLF procedure 608 (e.g., a RACH procedure) to recover from the radio link failure.

### Example Framework for AI/ML in a Radio Access Network

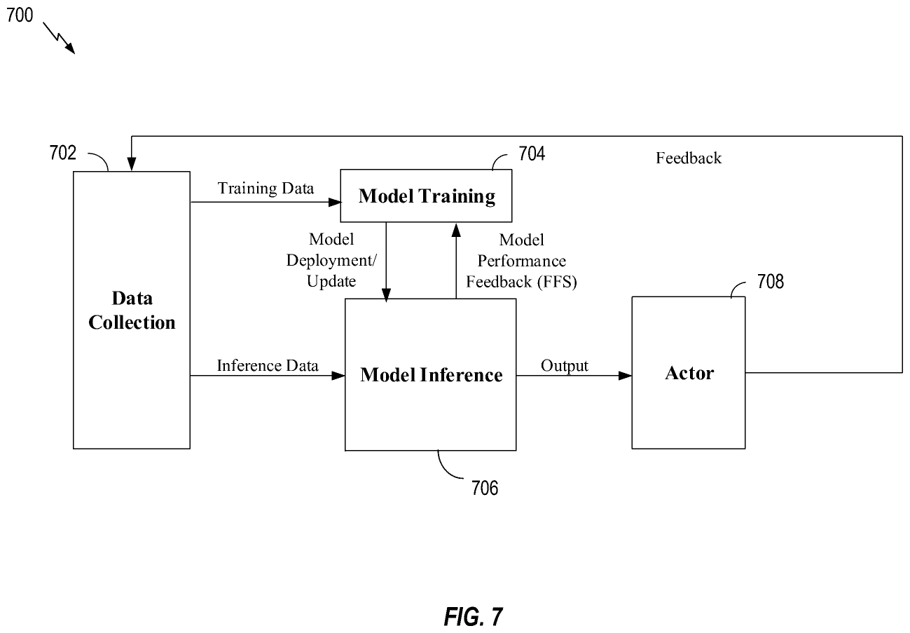

FIG. 7 depicts an example of AI/ML functional framework 700 for RAN intelligence, in which aspects described herein may be implemented.

The AI/ML functional framework includes a data collection function 702, a model training function 704, a model inference function 706, and an actor function 708, which interoperate to provide a platform for collaboratively applying AI/ML to various procedures in RAN.

The data collection function 702 generally provides input data to the model training function 704 and the model inference function 706. AI/ML algorithm specific data preparation (e.g., data pre-processing and cleaning, formatting, and transformation) may not be carried out in the data collection function 702.

Examples of input data to the data collection function 702 (or other functions) may include measurements from UEs or different network entities, feedback from the actor function, and output from an AI/ML model. In some cases, analysis of data needed at the model training function 704 and the model inference function 706 may be performed at the data collection function 702. As illustrated, the data collection function 702 may deliver training data to the model training function 704 and inference data to the model inference function 706.

The model training function 704 may perform AI/ML model training, validation, and testing, which may generate model performance metrics as part of the model testing procedure. The model training function 704 may also be responsible for data preparation (e.g., data pre-processing and cleaning, formatting, and transformation) based on the training data delivered by the data collection function 702, if required.

The model training function 704 may provide model deployment/update data to the Model interface function 706. The model deployment/update data may be used to initially deploy a trained, validated, and tested AI/ML model to the model inference function 706 or to deliver an updated model to the model inference function 706.

As illustrated, the model inference function 706 may provide AI/ML model inference output (e.g., predictions or decisions) to the actor function 708 and may also provide model performance feedback to the model training function 704, at times. The model inference function 706 may also be responsible for data preparation (e.g., data pre-processing and cleaning, formatting, and transformation) based on inference data delivered by the data collection function 702, at times.

The inference output of the AI/ML model may be produced by the model inference function 706. Specific details of this output may be specific in terms of use cases. The model performance feedback may be used for monitoring the performance of the AI/ML model, at times. In some cases, the model performance feedback may be delivered to the model training function 704, for example, if certain information derived from the model inference function is suitable for improvement of the AI/ML model trained in the model training function 704.

The model inference function 706 may signal the outputs of the model to nodes that have requested them (e.g., via subscription), or nodes that take actions based on the output from the model inference function. An AI/ML model used in a model inference function 706 may need to be initially trained, validated and tested by a model training function before deployment. The model training function 704 and model inference function 706 may be able to request specific information to be used to train or execute the AI/ML algorithm and to avoid reception of unnecessary information. The nature of such information may depend on the use case and on the AI/ML algorithm.

The actor function 708 may receive the output from the model inference function 706, which may trigger or perform corresponding actions. The actor function 708 may trigger actions directed to other entities or to itself. The feedback generated by the actor function 708 may provide information used to derive training data, inference data or to monitor the performance of the AI/ML Model. As noted above, input data for a data collection function 702 may include this feedback from the actor function 708. The feedback from the actor function 708 or other network entities (e.g., via Data Collection function) may also be used at the model inference function 706.

The AI/ML functional framework 700 may be deployed in various RAN intelligence-based use cases. Such use cases may include CSI feedback enhancement, enhanced beam management (BM), positioning and location (Pos-Loc) accuracy enhancement, and various other use cases.

### Overview of Inter-Cell Measurement and Reporting Configuration

A UE may be configured (e.g., via RRC signaling) for measurement and reporting for inter-cell beam management (BM). For the measurement, the UE may be configured with at least one CSI-SSB-ResourceSet that includes at least a set of non-Cell SSBs with non-serving PCIs. Additional non-serving SSB information may also be provided by RRC. This information may include position, Tx power, and periodicity of non-serving SSB transmissions). In some cases, a maximum number of non-serving PCIs configured for measurement may be based on a UE capability (e.g., with a candidate value at least including 1). UE measurement behavior for overlapped SSBs may be up to standards or implementation.

For measurement reporting, different parameters may be included. For example, in some cases a differential L1-RSRP report format may be assumed (e.g., where the UE reports a strongest measured L1-RSRP for one beam/resource and reports differential values for the other measurements). In some cases, the UE may report up to 4 DL RSs, which can include both Cell RS and non-serving SSB.

A layer 1 (L1) measurement report (e.g., for L1/L2 mobility (LTM)), may be reported as UCI on PUCCH or PUSCH. For example, periodic reports may be transmitted on PUCCH, semi-persistent reports may be transmitted on PUCCH/PUSCH, and aperiodic reports may be transmitted on PUSCH. In some cases, such reporting may be via medium access control (MAC) control element (CE). Both gNB scheduled and/or UE initiated reporting may be possible.

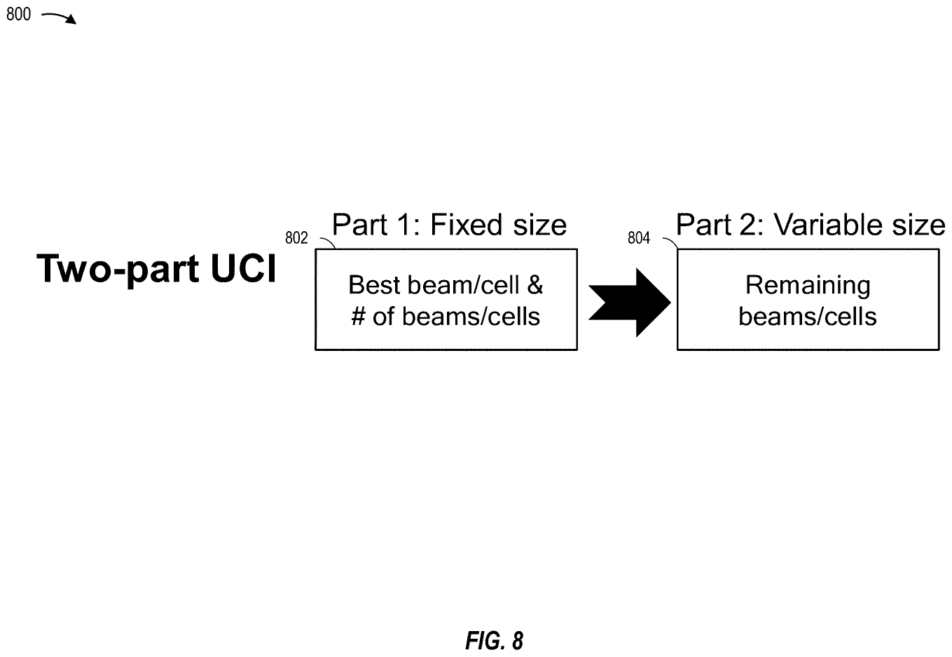

As illustrated in FIG. 8, a two-part UCI 800 (e.g., a flexible size beam report) may be utilized, where a first part 802 may be of a fixed size while a second part 804 may be of variable size. In such cases, the first part 802 may contain the best beam/cell and the number (e.g., N) of reported beams/cells. The second part 804 may contain the rest (N-1) of the beams/cells.

Using such a UCI format may allow reductions of reporting overhead (e.g., by choosing beams/cells per frequency or across frequencies to report).

### Aspects Related to Target Beam Identification for Temporal Beam Prediction

As noted above, certain mobility procedures may be in place to help maintain network connections for a UE as it moves between the coverage areas of different cells. For example, such mobility procedures may allow a UE to transition from being served by a source cell to being served by a target cell. For LTM, as a UE moves, a new serving cell (e.g. a primary cell (Pcell)) may be selected (e.g., reselected) among a set of pre-configured candidate cells based on L1 measurement for those cells. LTM procedures may provide improved robustness against blocking, improved higher rank chances across different cells, and reduced latency across different cells.

In some cases, a large number of reference signals (RSs) in LTM candidate cell(s) may be monitored. In order for a network entity (e.g., a gNB) to dynamically signal updates on which RSs should be monitored, complexity and/or overhead consumption may increase and may become excessive as the number of RSs increases.

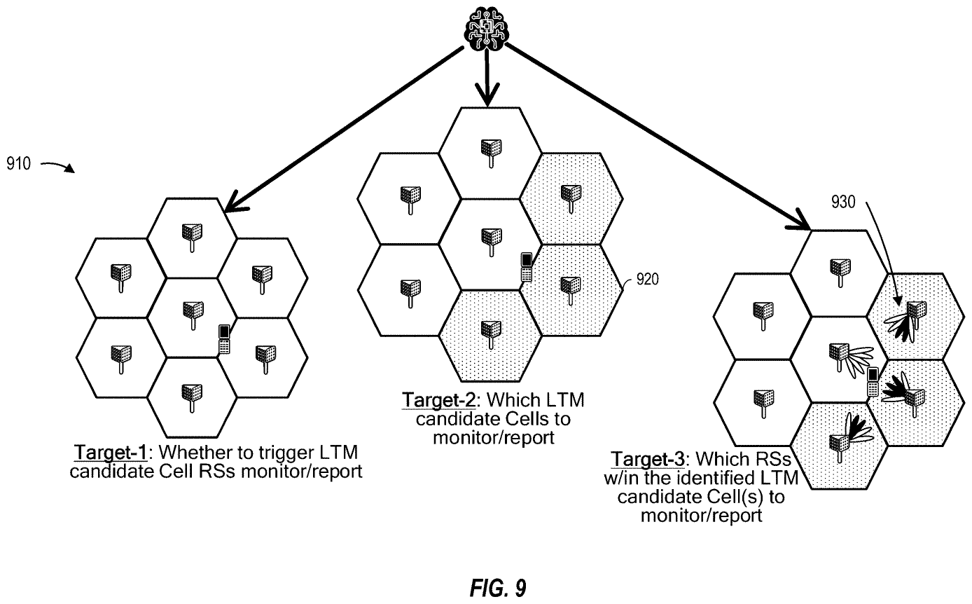

FIG. 9 depicts target scenarios involving LTM. For example, a network entity (e.g., a UE or gNB) may use AI/ML to determine, recommend, and/or report certain information as a UE moves within a LTM candidate cells 910. For example, as illustrated as Target-1 in FIG. 9, AI/ML may be used to determine/recommend/report whether to trigger monitoring/reporting of LTM candidate cells' RS. As illustrated as Target-2 in FIG. 9, AI/ML may also be used to determine/recommend/report which (a set 920) of LTM candidate cells for the UE to monitor/report (e.g., based on UE location relative to the candidate cells). As illustrated as Target-3 in FIG. 9, AI/ML may also be used to determine/recommend/report which RSs/beams 930 (e.g., within the set of LTM candidate cells 920) are to be monitored/reported, and/or when/how to report the monitored beam qualities. In the illustrated example, the shading (filling) indicates RSs/beams that have been chosen for monitoring/reporting.

AI/ML-based LTM may provide certain advantages. For example, from a UE perspective, power consumption for mobility may be reduced. From a network perspective (e.g., if the UE does NOT report/recommend certain information), less dynamic signaling may be needed to reconfigure the measurement of RSs.

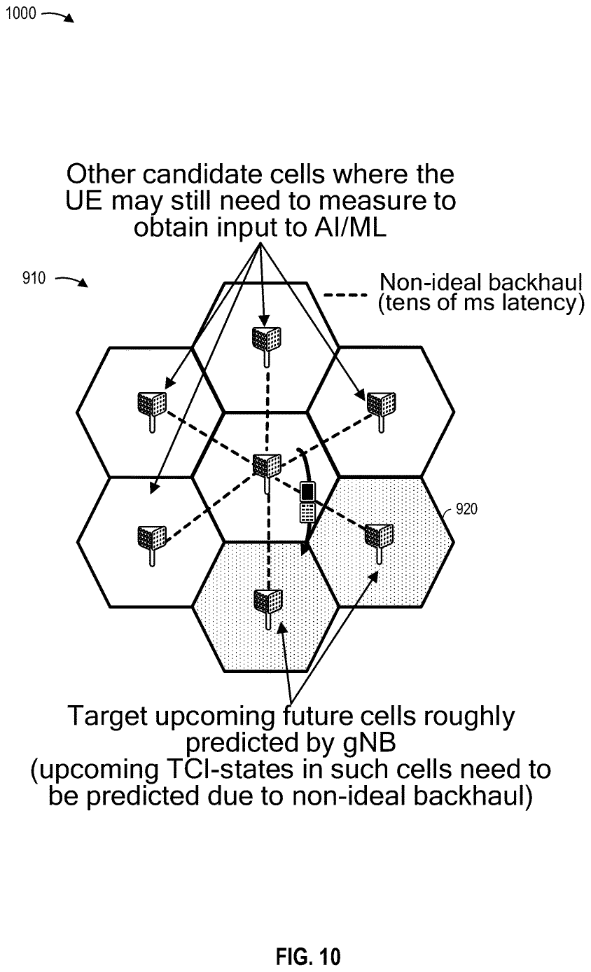

FIG. 10 depicts an example scenario 1000 involving time domain (TD) beam prediction for LTM. As noted above, for example, a network entity (e.g., a gNB) may be able to (e.g., roughly) predict which (e.g., 1 or 2) candidate cells 920 (e.g., among other candidate cells 910 measured by a UE) have higher probability to be switched to in an upcoming duration (e.g., based on the location of the UE). However, as illustrated in FIG. 10, delays of non-ideal backhaul may be tens of milliseconds. Thus, prediction of transmission configuration indicator (TCI) states in target candidate cells ahead of cell-switching may be needed.

On the other hand, due to restrictions/limitations of uplink control information (UCI) payload size, it may be advantageous to limit the UCI reporting of predictions for target beams to a limited amount in TD beam prediction (e.g., where the UE reports predicted channel characteristics regarding future occasions about candidate beams in candidate cells). For example, in certain wireless communications standards, an L1 report may only report measurements (e.g., L1-RSRP) for up to four CMRs and their respective CMR-IDs. When the number of candidate beams increases, the overhead to indicate their respective beam-IDs may become excessively large.

Aspects of the present disclosure provide techniques for a network entity to indicate (e.g., and dynamically update/adjust based on UE location/movement/rotation) target beams (and/or other target prediction resources) in target cells for prediction regarding certain future TD occasions. For example, a network entity may roughly predict and indicate future candidate cells/beams (e.g., target prediction resources) and transmit reference signals (RSs) to a UE (e.g., on CMRs), allowing the UE to predict channel characteristics associated with future (or current) TD occasions of the target prediction resources based on measurement of the RSS, and report the predicted channel characteristics to the network. As used herein, the term target prediction resources generally refers to time/frequency resources, associated transmission/reception beams, and/or candidate cells, for which channel characteristics may be predicted for current or future TD occasions. For example, a UE may measure RSs transmitted on CMRs in one or more TD occasions and may predict channel characteristics for target prediction resources for one or more future TD occasions (e.g., 40-160 ms later), based on the measurements.

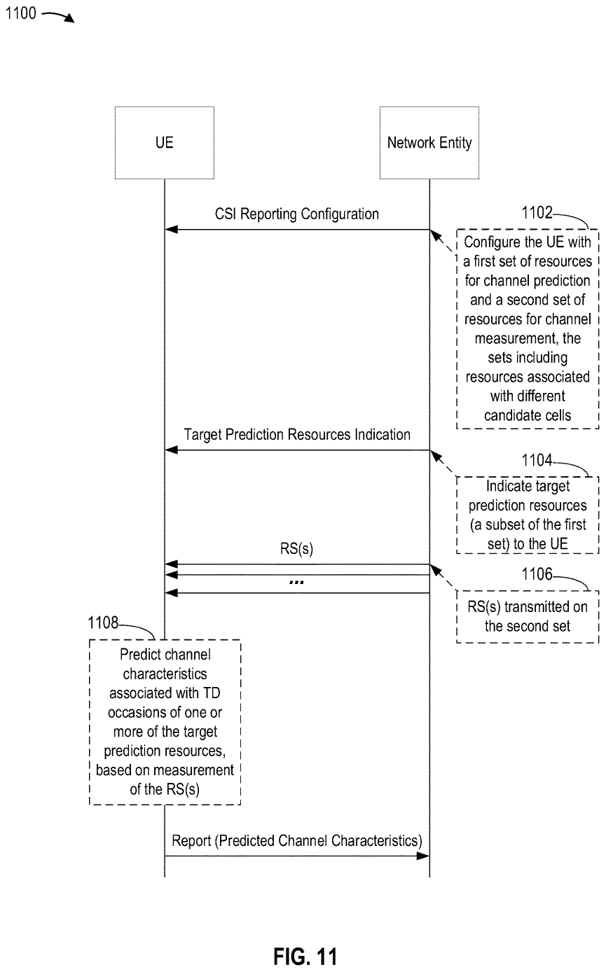

FIG. 11 depicts a call flow diagram 1100, in accordance with certain aspects of the present disclosure. In some aspects, the UE shown in FIG. 11 may be an example of the UE 104 depicted and described with respect to FIGS. 1 and 3. In some aspects, the network entity shown in FIG. 11 may be an example of the BS 102 (e.g., a gNB) depicted and described with respect to FIGS. 1 and 3 or a disaggregated base station depicted and described with respect to FIG. 2.

As illustrated at 1102, the network entity may transmit configuration information (e.g., a CSI reporting configuration) configuring a UE with a first set of resources for channel prediction (e.g., a channel prediction resource (CPR) set) and a second set of resources for channel measurement (e.g., a channel measurement resource (CMR) set), the sets including resources associated with different candidate cells.

As illustrated at 1104, the network entity may then transmit an indication of target prediction resources (e.g., which may be a subset of the first set) to the UE.

As illustrated at 1106, the network entity may then transmit one or more RSs to the UE using resources of the second set. The RSs may be transmitted from multiple cells (e.g., via RUs of different LTM cells).

As illustrated at 1108, the UE may receive/measure the RSs and predict channel characteristics associated with TD occasions of one or more of the target prediction resources based on the measurement of the RSs. As illustrated, the UE may then transmit a report indicating the predicted channel characteristics.

In some aspects, the network entity may receive the report, select an LTM candidate cell, and signal (e.g., using dynamic mobility or “LTM” signaling) the UE to switch to that candidate cell.

Different methods may be used to indicate target prediction resources/beams (e.g., via MAC-CE/DCI). For example, in some aspects, a network entity may use MAC-CE/DCI to indicate the Cell-ID(s) associated with the target prediction resources that should be addressed in the CSI report. In some aspects, a network entity may indicate the prediction resource set ID(s) associated with the target prediction resources that should be addressed in the CSI report. In some cases, each prediction resource set may be associated with a separate candidate cell.

In some aspects, a network entity may indicate subset(s) of the prediction resource set(s), where multiple prediction resource sets may be associated with the same candidate cell.

In some aspects, a network entity may indicate the prediction resource ID(s) associated with the target prediction resources that should be addressed in the CSI report.

In some cases, these different types of signaling for indicating the target prediction resources/beams may be used jointly, for example, by indicating subset(s) of the prediction resource ID(s).

In some aspects, the MAC-CE used for indicating the target prediction resources/beams may be a MAC-CE activating the (e.g., semi-persistent (SP)) CSI report, or a separate/dedicated MAC-CE. In some aspects, this may be based on RRC preconfiguration of multiple options, and the MAC-CE may select one or more of the multiple options. In some aspects, the MAC-CE may explicitly indicate the target prediction resources/beams.

In some aspects, the MAC-CE may activate a number of options that have been RRC preconfigured in the CSI report setting, and a DCI may further be used to select one of the activated options.

In some aspects, the DCI used for indicating the target prediction resources/beams may be a DCI triggering the (e.g., aperiodic (AP)) CSI report, or one or more dedicated DCI fields in a separate DCI (e.g., a DL-grant DCI).

In some aspects, the DCI used for indicating the target prediction resources/beams may be a DCI triggering a CSI report (e.g., an aperiodic AP CSI report) or may be a DCI that includes a dedicated field (or fields) for the indication, or may be a separate DCI. If a DCI triggering an AP CSI report is used, the triggering may be based on a CSI-AssociatedReportConfigInfo parameter in the AP CSI report.

If one or more dedicated DCI fields are used, the indication of the target prediction resources/beams may be based on RRC preconfiguration of multiple options, where a MAC-CE may optionally activate a subset of the options, and the DCI field may select one of such options. In some aspects, the DCI field may select one of the multiple options without MAC-CE activation of a subset of the options.

In some aspects, details/contents of the CSI report payload may vary. For example, if a single (1-Part) CSI is used, where the CSI report is comprised of a single part with fixed payload size, the reported prediction resource IDs may only be selected from the gNB indicated ones or selected from the UE first reported ones.

For example, prediction resources (e.g., from #1 to #128) may originally be configured for the CSI report setting ordered across all candidate Cells (e.g., 8 candidate cells). When gNB indicates (e.g., via MAC-CE/DCI) to select (e.g., down-select) to a single cell to be addressed in the CSI report, such target prediction resources (e.g., #2/#4/#7/#15/#16/#18/#19/#26) may be re-ordered to map to codepoints #1-to-#8, such that only 3-bits are needed to report each resource-ID (comparing to 7-bits if no such down-selection is indicated from gNB).

In some aspects, the number of prediction resources associated with different Cells or different prediction resource sets may be expected to be identical so that the overall payload size is fixed. In such cases, a 1-Part CSI may be considered.

In some aspects, a 2-Part CSI may be used, as described above with reference to FIG. 8, where a first part (CSI Part-1) has a fixed payload size and a second part (CSI Part-2) has a flexible payload size (which may be identified based on CSI Part-2). For example, a UE may first report the payload in CSI Part-1, and then it may further report the number of prediction resources that it would like to address in CSI Part-2. The UE may then report the corresponding prediction resource IDs together with their predicted channel characteristics in CSI Part-2.

For example, the number of prediction resources associated with different cells or different prediction resource sets may be different, where the UE reports the specific cell IDs or the specific prediction resource set IDs in CSI Part-1 (e.g., with fixed payload size), while the resource IDs may be addressed in CSI Part-2 (e.g., with flexible payload size and determined by CSI Part-1).

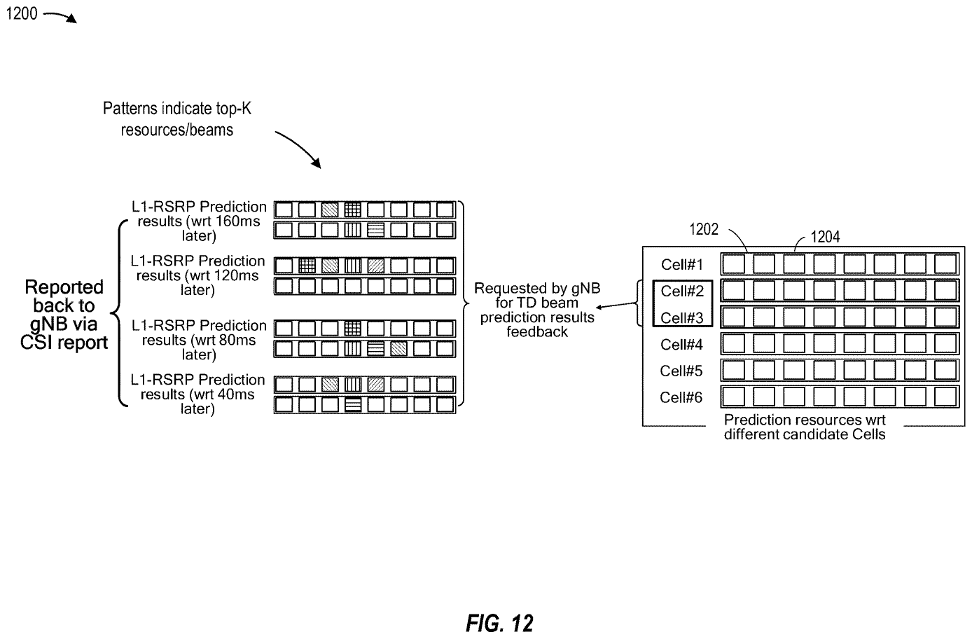

FIG. 12 depicts an example diagram 1200 illustrating target beam identification for temporal beam prediction, in accordance with certain aspects of the present disclosure.

As noted above, aspects of the present disclosure provide techniques for network entity (e.g., gNB) controlled target beam identification for UE-Side TD Beam Prediction in LTM. For example, a UE may be configured with a CSI report setting associated with one or more measurement resource sets (e.g., CMR sets) and one or more prediction resource sets (e.g., CPR sets), wherein a reportQuantity field of the CSI report includes at least predicted channel characteristics (including L1-RSRP/L1 signal to interference and noise ratio (SINR)/top-K-resources) regarding one or more future TD occasions associated with the prediction resources in certain prediction resource sets.

As illustrated in FIG. 12, for example, a gNB may request TD beam prediction results for RS resource sets 1202 of one or more cells (e.g., Cell #2 and Cell #3 in this example). Each resource set 1202 includes multiple RS resources 1204, each of which may be associated with a different beam (used to transmit RS on that resource).

As illustrated, the UE may then perform (e.g., LI-RSRP) predictions for one or more (e.g., future) TD occasions. As used in this context, a TD occasion generally refers to a current or future time period for which channel characteristics predictions (e.g., of L1-RSRP) are predicted (e.g., based on current and/or past measurements of CMR RS transmissions). As will be described below, predictions for a same TD occasion in which CMR RS measurements are taken may be considered spatial-only prediction. As illustrated in the example of FIG. 12, the UE performs L1-RSRP predictions for TD occasions that occur 40 ms, 80 ms, 120 ms, and 160 ms later. In some aspects, as illustrated by the various patterns on resources/beams 1204 in each L1-RSRP prediction, the UE may determine the top K resources (e.g., as a rank ordered list) for each TD occasion, and may report these prediction results back to the gNB via a CSI report. The illustrated example assumes K=4, such that the top 4 resources are reported, as indicated by different cross-hatching.

In some aspects, resources in the measurement resource sets may be comprised of SSBs/CSI-RSs. In some aspects, resources in the prediction resource sets may be comprised of SSBs/CSI-RSs or virtual resources that are not actually transmitted.

In some aspects, the top-K-resources described above, which may be included in the CSI report, may be a ranking or a list of the top K most favorable resources based on the (e.g., strength of the) L1-RSRP/L1-SINR.

In some aspects, the measurement resources and/or the prediction resources may be associated with different cells. For example, the measurement resources and/or the prediction resources may be associated with different LTM candidate cells.

In some aspects, the UE receives signaling from the network (e.g., via RRC/MAC-CE/DCI), on candidate prediction resources that are to be addressed in the CSI report. In some aspects, the remaining candidate prediction resources (e.g., that are not requested by gNB through such signaling) are not to be addressed in the CSI report.

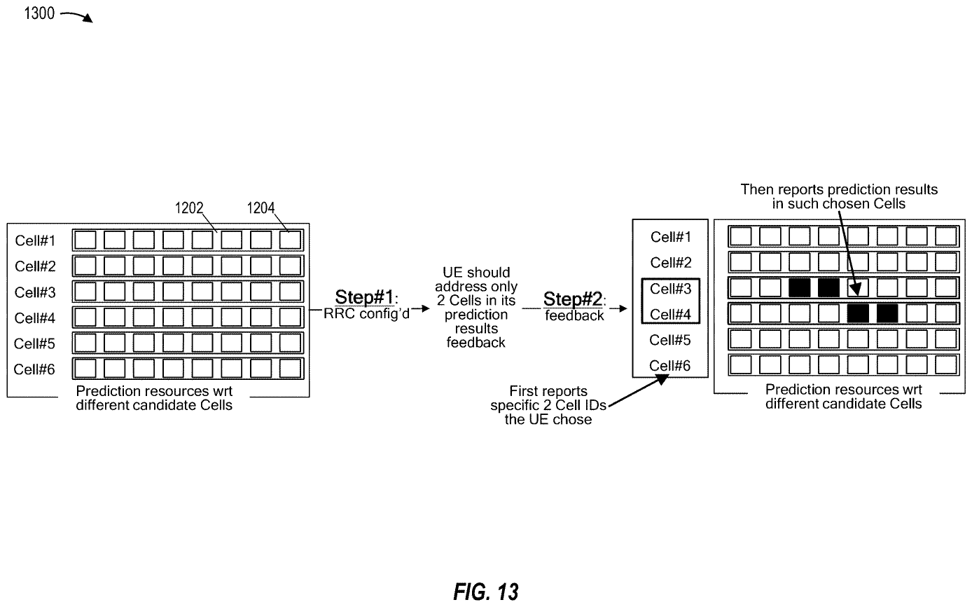

FIG. 13 depicts an example diagram 1300 illustrating target beam identification for temporal beam prediction, in accordance with certain aspects of the present disclosure. The example assumes the same configuration of resource sets 1202 for an example set of cells (Cells #1-6).

Aspects of the present disclosure provide certain methods to configure target prediction beams (e.g., via RRC signaling). For example, as illustrated in FIG. 13, a first step (Step #1) may relate to gNB configuration of a number of cells or prediction resource sets. For example, a gNB may use RRC to configure (e.g., in the CSI report setting) the number of cells or the number of prediction resource sets associated with the target prediction resources that are to be addressed in the CSI report by the UE. In the illustrated example, the gNB indicates that the UE should only address two cells (Cell #3 and Cell #4 in this example) in the prediction results/report.

As illustrated, a first step (Step #2) may relate to UE reporting of specific cell IDs or prediction resource set IDs in the CSI report. For example, the UE may first report the specific cell IDs or the specific prediction resource set IDs that it chose to be included in the corresponding CSI report occasion. The UE may further report prediction resource IDs and their predicted channel characteristics.

In some aspects (e.g., in order to guarantee a fixed CSI payload size), each cell or each prediction resource set may include an identical number of prediction resources such that the payload to report resource IDs is fixed. Otherwise, 2-Part CSI may be used, wherein the UE reports the specific cell IDs or the specific prediction resource set IDs in CSI Part-1 (e.g., with fixed payload size), while the resource IDs may be addressed in CSI Part-2 (e.g., with flexible payload size and determined by CSI Part-1).

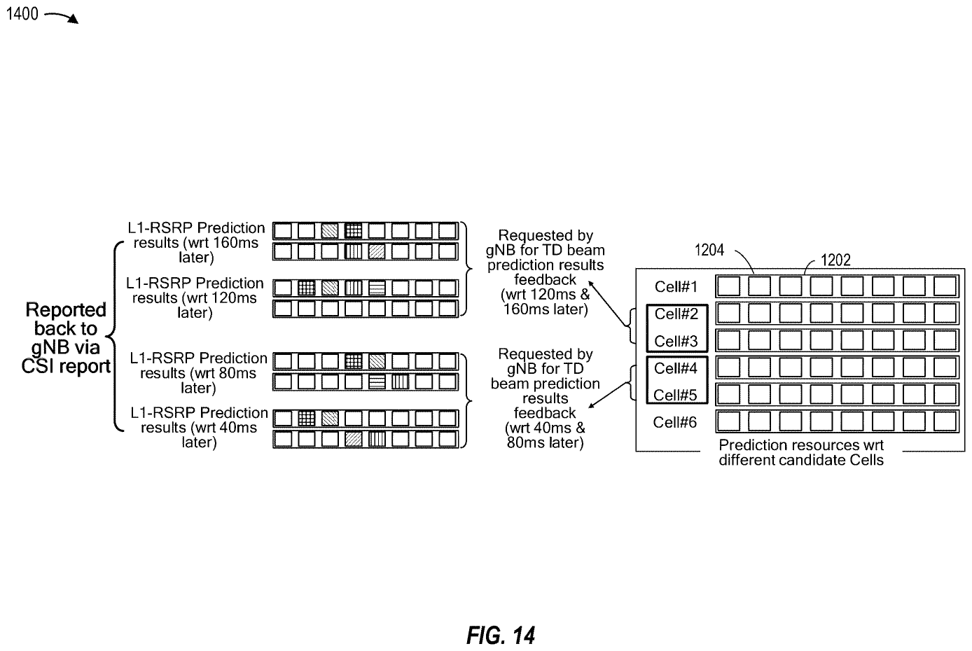

FIG. 14 depicts an example diagram 1400 illustrating target beam identification for temporal beam prediction, in accordance with certain aspects of the present disclosure.

In some aspects, the gNB may request TD beam prediction for different future TD occasions associated with different target prediction resources. For example, a reportQuantity field of the CSI report may include predicted channel characteristics regarding these multiple future TD occasions. The gNB configuration/indication of candidate prediction resources that should be addressed in the CSI report may be different for different future TD occasions.

For example, as illustrated in FIG. 14, the gNB may request TD beam prediction for TD occasions occurring 40 ms and 80 ms later for a first subset of cells (Cell #4 and Cell #5 in this example) while requesting TD beam prediction for TD occasions occurring 120 ms and 160 ms later for a second subset of cells (Cell #2 and Cell #3 in this example). The illustrated prediction results for the candidate cells and their respective requested TD occasions may be reported back to gNB via the CSI report.

In some aspects, the techniques disclosed herein may be applied to single-cell cases. For example, gNB configurations/indications of target candidate prediction resources that should be addressed in the CSI report, may be based on a single cell.

In some aspects, the techniques proposed herein may be applied even if temporal prediction is not performed. In this case, the prediction may be considered as falling back to a purely spatial domain beam prediction scenario, for example, when the reportQuantity field of the CSI report comprises only predicted channel characteristics regarding the prediction resources, with respect to the same TD occasion in which the UE measured the measurement resources associated with the CSI report.

### Example Operations

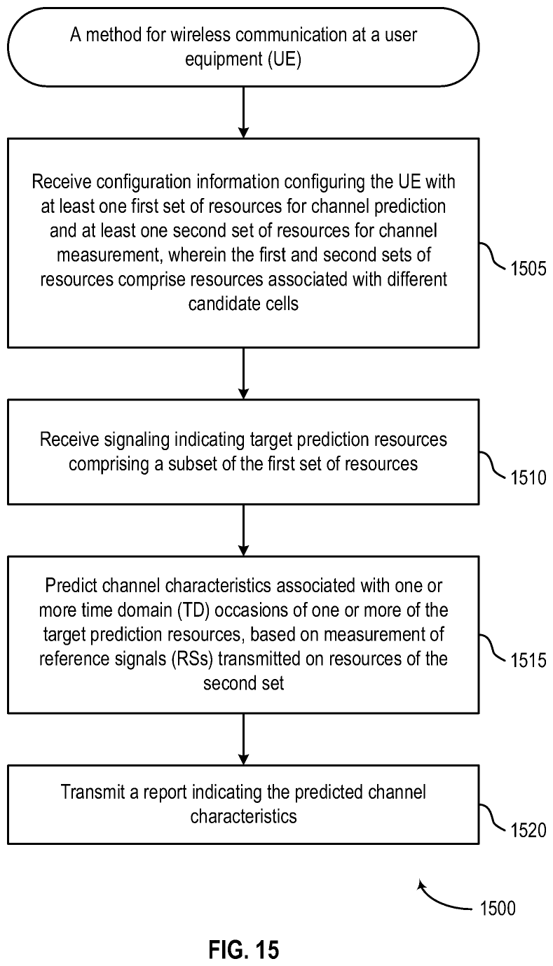

FIG. 15 shows an example of a method 1500 of wireless communication at a user equipment (UE), such as a UE 104 of FIGS. 1 and 3.

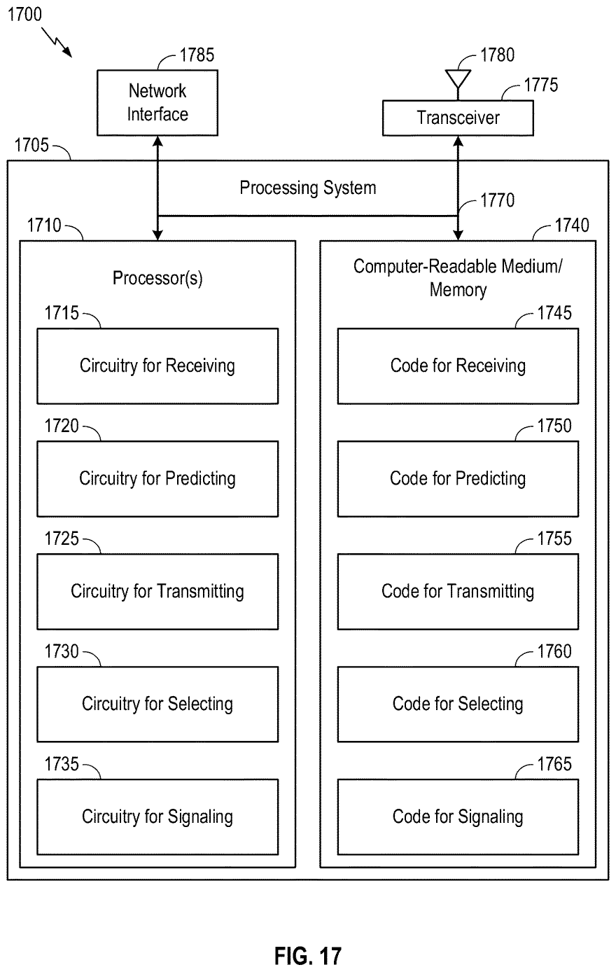

Method 1500 begins at step 1505 with receiving configuration information configuring the UE with at least one first set of resources for channel prediction and at least one second set of resources for channel measurement, wherein the first and second sets of resources comprise resources associated with different candidate cells. In some cases, the operations of this step refer to, or may be performed by, circuitry for receiving and/or code for receiving as described with reference to FIG. 17.

Method 1500 then proceeds to step 1510 with receiving signaling indicating target prediction resources comprising a subset of the first set of resources. In some cases, the operations of this step refer to, or may be performed by, circuitry for receiving and/or code for receiving as described with reference to FIG. 17.

Method 1500 then proceeds to step 1515 with predicting channel characteristics associated with one or more time domain (TD) occasions of one or more of the target prediction resources, based on measurement of reference signals (RSs) transmitted on resources of the second set. In some cases, the operations of this step refer to, or may be performed by, circuitry for predicting and/or code for predicting as described with reference to FIG. 17.

Method 1500 then proceeds to step 1520 with transmitting a report indicating the predicted channel characteristics. In some cases, the operations of this step refer to, or may be performed by, circuitry for transmitting and/or code for transmitting as described with reference to FIG. 17.

In some aspects, the UE supports signaling (e.g., dynamic mobility signaling) to switch between the candidate cells via physical (PHY) layer or medium access control (MAC) layer signaling. Dynamic mobility signaling may refer to signaling associated with layer 1/2 (L1/L2)-triggered mobility (LTM). For example, dynamic mobility signaling may be used to indicate, via DCI and/or a MAC CE, that a UE is to switch between candidate cells.

In some aspects, the predicted channel characteristics comprise at least one of PHY layer reference signal received power (RSRP) or PHY layer signal to interference and noise ratio (SINR).

In some aspects, the report indicates the predicted channel characteristics for a limited number of resources of the first set, based on ranked values of the PHY layer RSRP or SINR.

In some aspects, the RSs transmitted on resources of the second set of resources comprise at least one of synchronization signal blocks (SSBs) or channel state information (CSI) reference signals (RSS).

In some aspects, the first set of resources comprise virtual resources on which reference signals are not transmitted; and the report includes channel characteristics predicted for virtual resources based on measurement of RSs transmitted on resources of the second set.

In some aspects, the signaling indicating target prediction resources is received via at least one of radio resource control (RRC) signaling, a medium access control (MAC) control element (CE), or downlink control information (DCI).

In some aspects, the signaling indicating target prediction resources is received via: a MAC CE that activates semi-persistent (SP) channel state information (CSI) reporting; a first type of DCI triggering aperiodic CSI reporting; or a field in a second type of DCI.

In some aspects, the signaling indicating target prediction resources is received via a MAC CE that activates semi-persistent (SP) channel state information (CSI) reporting.

In some aspects, the signaling indicates the target prediction resources using at least one of: one or more cell identifiers (IDs) associated with the target prediction resources, one or more resource set IDs associated with the target prediction resources, or one or more resource IDs associated with the target prediction resources.

In some aspects, the report indicates: at least one of the one or more cell IDs or resource set IDs; one or more resource IDs associated with the one or more cell IDs or resource set IDs and predicted channel characteristics corresponding to the one or more resource IDs.

In some aspects, the report is transmitted in at least two parts, including a first part with a fixed payload size and a second part with a flexible payload size determined based on information in the first part.

In some aspects, the signaling indicates different target prediction resources associated with different future TD occasions.

In some aspects, predicting channel characteristics associated with one or more TD occasions of one or more of the target prediction resources, based on measurement of RSs transmitted on resources of the second set, comprises: predicting channel characteristics associated with a single TD occasion in which the UE measures RSs transmitted on resources of the second set.

In one aspect, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative steps are possible consistent with this disclosure.

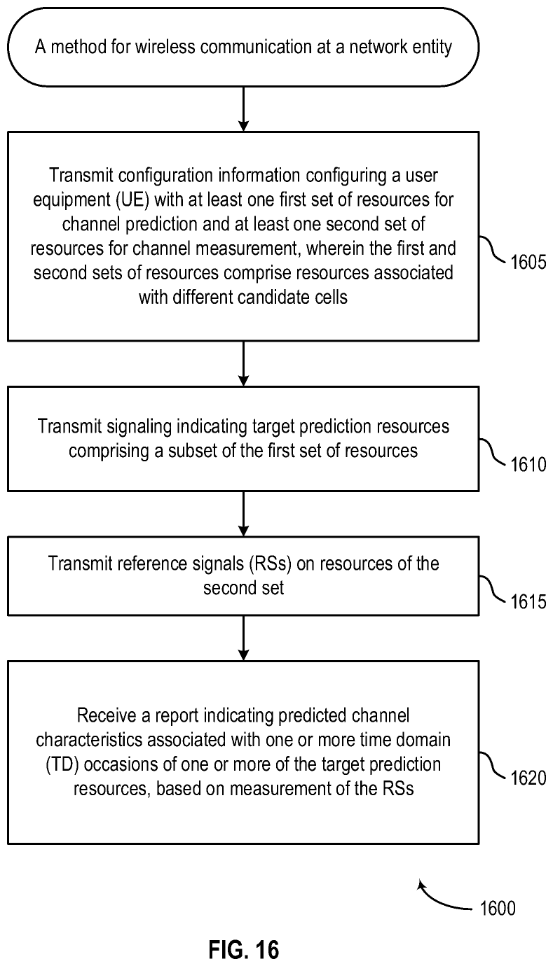

FIG. 16 shows an example of a method 1600 of wireless communication at a network entity, such as a BS 102 of FIGS. 1 and 3, or a disaggregated base station as discussed with respect to FIG. 2.

Method 1600 begins at step 1605 with transmitting configuration information configuring a user equipment (UE) with at least one first set of resources for channel prediction and at least one second set of resources for channel measurement, wherein the first and second sets of resources comprise resources associated with different candidate cells. In some cases, the operations of this step refer to, or may be performed by, circuitry for transmitting and/or code for transmitting as described with reference to FIG. 17.

Method 1600 then proceeds to step 1610 with transmitting signaling indicating target prediction resources comprising a subset of the first set of resources. In some cases, the operations of this step refer to, or may be performed by, circuitry for transmitting and/or code for transmitting as described with reference to FIG. 17.

Method 1600 then proceeds to step 1615 with transmitting reference signals (RSs) on resources of the second set. In some cases, the operations of this step refer to, or may be performed by, circuitry for transmitting and/or code for transmitting as described with reference to FIG. 17.

Method 1600 then proceeds to step 1620 with receiving a report indicating predicted channel characteristics associated with one or more time domain (TD) occasions of one or more of the target prediction resources, based on measurement of the RSs. In some cases, the operations of this step refer to, or may be performed by, circuitry for receiving and/or code for receiving as described with reference to FIG. 17.

In some aspects, the method 1600 further includes selecting one of the candidate cells based on the report. In some cases, the operations of this step refer to, or may be performed by, circuitry for selecting and/or code for selecting as described with reference to FIG. 17.

In some aspects, the method 1600 further includes signaling the UE to switch to the selected candidate cell via physical (PHY) layer or medium access control (MAC) layer signaling. In some cases, the operations of this step refer to, or may be performed by, circuitry for signaling and/or code for signaling as described with reference to FIG. 17.

In some aspects, the predicted channel characteristics comprise at least one of PHY layer reference signal received power (RSRP) or PHY layer signal to interference and noise ratio (SINR).

In some aspects, the report indicates the predicted channel characteristics for a limited number of resources of the first set, based on ranked values of the PHY layer RSRP or SINR.

In some aspects, the RSs comprise at least one of synchronization signal blocks (SSBs) or channel state information (CSI) reference signals (RSs).

In some aspects, the first set of resources comprise virtual resources on which RSs are not transmitted; and the report includes channel characteristics predicted for virtual resources based on measurement of the RSs transmitted on resources of the second set.

In some aspects, the signaling indicating target prediction resources is transmitted via at least one of radio resource control (RRC) signaling, a medium access control (MAC) control element (CE), or downlink control information (DCI).

In some aspects, the signaling indicating target prediction resources is transmitted via: a MAC CE that activates semi-persistent (SP) channel state information (CSI) reporting; a first type of DCI triggering aperiodic CSI reporting; or a field in a second type of DCI.

In some aspects, the signaling indicating target prediction resources is transmitted via a MAC CE that activates semi-persistent (SP) channel state information (CSI) reporting.

In some aspects, the signaling indicates the target prediction resources using at least one of: one or more cell identifiers (IDs) associated with the target prediction resources, one or more resource set IDs associated with the target prediction resources, or one or more resource IDs associated with the target prediction resources.

In some aspects, the report indicates: at least one of the one or more cell IDs or resource set IDs; one or more resource IDs associated with the one or more cell IDs or resource set IDs and predicted channel characteristics corresponding to the one or more resource IDs.

In some aspects, the report is received in at least two parts, including a first part with a fixed payload size and a second part with a flexible payload size determined based on information in the first part.

In some aspects, the signaling indicates different target prediction resources associated with different future TD occasions.

In some aspects, the predicted channel characteristics are associated with a single TD occasion in which the UE measures the RSs transmitted on resources of the second set.

In one aspect, method 1600, or any aspect related to it, may be performed by an apparatus, such as communications device 1700 of FIG. 17, which includes various components operable, configured, or adapted to perform the method 1600. Communications device 1700 is described below in further detail.

Note that FIG. 16 is just one example of a method, and other methods including fewer, additional, or alternative steps are possible consistent with this disclosure.

### Example Communications Device(s)

FIG. 17 depicts aspects of an example communications device 1700. In some aspects, communications device 1700 is a user equipment, such as UE 104 described above with respect to FIGS. 1 and 3. In some aspects, communications device 1700 is a network entity, such as BS 102 of FIGS. 1 and 3, or a disaggregated base station as discussed with respect to FIG. 2.

The communications device 1700 includes a processing system 1705 coupled to the transceiver 1775 (e.g., a transmitter and/or a receiver). In some aspects (e.g., when communications device 1700 is a network entity), processing system 1705 may be coupled to a network interface 1785 that is configured to obtain and send signals for the communications device 1700 via communication link(s), such as a backhaul link, midhaul link, and/or fronthaul link as described herein, such as with respect to FIG. 2. The transceiver 1775 is configured to transmit and receive signals for the communications device 1700 via the antenna 1780, such as the various signals as described herein. The processing system 1705 may be configured to perform processing functions for the communications device 1700, including processing signals received and/or to be transmitted by the communications device 1700.

The processing system 1705 includes one or more processors 1710. In various aspects, the one or more processors 1710 may be representative of one or more of receive processor 358, transmit processor 364, TX MIMO processor 366, and/or controller/processor 380, as described with respect to FIG. 3. In various aspects, one or more processors 1710 may be representative of one or more of receive processor 338, transmit processor 320, TX MIMO processor 330, and/or controller/processor 340, as described with respect to FIG. 3. The one or more processors 1710 are coupled to a computer-readable medium/memory 1740 via a bus 1770. In certain aspects, the computer-readable medium/memory 1740 is configured to store instructions (e.g., computer-executable code) that when executed by the one or more processors 1710, cause the one or more processors 1710 to perform the method 1500 described with respect to FIG. 15, or any aspect related to it; and the method 1600 described with respect to FIG. 16, or any aspect related to it. Note that reference to a processor performing a function of communications device 1700 may include one or more processors 1710 performing that function of communications device 1700.

In the depicted example, computer-readable medium/memory 1740 stores code (e.g., executable instructions), such as code for receiving 1745, code for predicting 1750, code for transmitting 1755, code for selecting 1760, and code for signaling 1765. Processing of the code for receiving 1745, code for predicting 1750, code for transmitting 1755, code for selecting 1760, and code for signaling 1765 may cause the communications device 1700 to perform the method 1500 described with respect to FIG. 15, or any aspect related to it; and the method 1600 described with respect to FIG. 16, or any aspect related to it.

The one or more processors 1710 include circuitry configured to implement (e.g., execute) the code stored in the computer-readable medium/memory 1740, including circuitry for receiving 1715, circuitry for predicting 1720, circuitry for transmitting 1725, circuitry for selecting 1730, and circuitry for signaling 1735. Processing with circuitry for receiving 1715, circuitry for predicting 1720, circuitry for transmitting 1725, circuitry for selecting 1730, and circuitry for signaling 1735 may cause the communications device 1700 to perform the method 1500 described with respect to FIG. 15, or any aspect related to it; and the method 1600 described with respect to FIG. 16, or any aspect related to it.

Various components of the communications device 1700 may provide means for performing the method 1500 described with respect to FIG. 15, or any aspect related to it; and the method 1600 described with respect to FIG. 16, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1775 and the antenna 1780 of the communications device 1700 in FIG. 17. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1775 and the antenna 1780 of the communications device 1700 in FIG. 17.

### Example Clauses

Implementation examples are described in the following numbered clauses:

Clause 1: A method for wireless communication at a user equipment (UE), comprising: receiving configuration information configuring the UE with at least one first set of resources for channel prediction and at least one second set of resources for channel measurement, wherein the first and second sets of resources comprise resources associated with different candidate cells; receiving signaling indicating target prediction resources comprising a subset of the first set of resources; predicting channel characteristics associated with one or more time domain (TD) occasions of one or more of the target prediction resources, based on measurement of reference signals (RSs) transmitted on resources of the second set; and transmitting a report indicating the predicted channel characteristics.

Clause 2: The method of Clause 1, wherein: the UE supports signaling to switch between the candidate cells via physical (PHY) layer or medium access control (MAC) layer signaling.

Clause 3: The method of Clause 2, wherein the predicted channel characteristics comprise at least one of PHY layer reference signal received power (RSRP) or PHY layer signal to interference and noise ratio (SINR).

Clause 4: The method of Clause 3, wherein the report indicates the predicted channel characteristics for a limited number of resources of the first set, based on ranked values of the PHY layer RSRP or SINR.

Clause 5: The method of any one of Clauses 1-4 wherein the RSs transmitted on resources of the second set of resources comprise at least one of synchronization signal blocks (SSBs) or channel state information (CSI) reference signals (RSs).

Clause 6: The method of any one of Clauses 1-5, wherein: the first set of resources comprise virtual resources on which reference signals are not transmitted; and the report includes channel characteristics predicted for virtual resources based on measurement of RSs transmitted on resources of the second set.

Clause 7: The method of any one of Clauses 1-6, wherein the signaling indicating target prediction resources is received via at least one of radio resource control (RRC) signaling, a medium access control (MAC) control element (CE), or downlink control information (DCI).

Clause 8: The method of Clause 7, wherein the signaling indicating target prediction resources is received via: a MAC CE that activates semi-persistent (SP) channel state information (CSI) reporting; a first type of DCI triggering aperiodic CSI reporting; or a field in a second type of DCI.

Clause 9: The method of Clause 7, wherein the signaling indicating target prediction resources is received via a MAC CE that activates semi-persistent (SP) channel state information (CSI) reporting.

Clause 10: The method of any one of Clauses 1-9, wherein the signaling indicates the target prediction resources using at least one of: one or more cell identifiers (IDs) associated with the target prediction resources, one or more resource set IDs associated with the target prediction resources, or one or more resource IDs associated with the target prediction resources.

Clause 11: The method of Clause 10, wherein the report indicates: at least one of the one or more cell IDs or resource set IDs; one or more resource IDs associated with the one or more cell IDs or resource set IDs and predicted channel characteristics corresponding to the one or more resource IDs.

Clause 12: The method of Clause 11, wherein the report is transmitted in at least two parts, including a first part with a fixed payload size and a second part with a flexible payload size determined based on information in the first part.

Clause 13: The method of any one of Clauses 1-12, wherein the signaling indicates different target prediction resources associated with different future TD occasions.

Clause 14: The method of any one of Clauses 1-13, wherein predicting channel characteristics associated with one or more TD occasions of one or more of the target prediction resources, based on measurement of RSs transmitted on resources of the second set, comprises: predicting channel characteristics associated with a single TD occasion in which the UE measures RSs transmitted on resources of the second set.

Clause 15: A method for wireless communication at a network entity, comprising: transmitting configuration information configuring a user equipment (UE) with at least one first set of resources for channel prediction and at least one second set of resources for channel measurement, wherein the first and second sets of resources comprise resources associated with different candidate cells; transmitting signaling indicating target prediction resources comprising a subset of the first set of resources; transmitting reference signals (RSs) on resources of the second set; and receiving a report indicating predicted channel characteristics associated with one or more time domain (TD) occasions of one or more of the target prediction resources, based on measurement of the RSs.

Clause 16: The method of Clause 15, further comprising: selecting one of the candidate cells based on the report; and signaling the UE to switch to the selected candidate cell via physical (PHY) layer or medium access control (MAC) layer signaling.

Clause 17: The method of Clause 16, wherein the predicted channel characteristics comprise at least one of PHY layer reference signal received power (RSRP) or PHY layer signal to interference and noise ratio (SINR).

Clause 18: The method of Clause 17, wherein the report indicates the predicted channel characteristics for a limited number of resources of the first set, based on ranked values of the PHY layer RSRP or SINR.

Clause 19: The method of any one of Clauses 15-18 wherein the RSs comprise at least one of synchronization signal blocks (SSBs) or channel state information (CSI) reference signals (RSs).

Clause 20: The method of any one of Clauses 15-19, wherein: the first set of resources comprise virtual resources on which RSs are not transmitted; and the report includes channel characteristics predicted for virtual resources based on measurement of the RSs transmitted on resources of the second set.

Clause 21: The method of any one of Clauses 15-20, wherein the signaling indicating target prediction resources is transmitted via at least one of radio resource control (RRC) signaling, a medium access control (MAC) control element (CE), or downlink control information (DCI).

Clause 22: The method of Clause 21, wherein the signaling indicating target prediction resources is transmitted via: a MAC CE that activates semi-persistent (SP) channel state information (CSI) reporting; a first type of DCI triggering aperiodic CSI reporting; or a field in a second type of DCI.

Clause 23: The method of Clause 21, wherein the signaling indicating target prediction resources is transmitted via a MAC CE that activates semi-persistent (SP) channel state information (CSI) reporting.

Clause 24: The method of any one of Clauses 15-23, wherein the signaling indicates the target prediction resources using at least one of: one or more cell identifiers (IDs) associated with the target prediction resources, one or more resource set IDs associated with the target prediction resources, or one or more resource IDs associated with the target prediction resources.

Clause 25: The method of Clause 24, wherein the report indicates: at least one of the one or more cell IDs or resource set IDs; one or more resource IDs associated with the one or more cell IDs or resource set IDs and predicted channel characteristics corresponding to the one or more resource IDs.

Clause 26: The method of Clause 25, wherein the report is received in at least two parts, including a first part with a fixed payload size and a second part with a flexible payload size determined based on information in the first part.

Clause 27: The method of any one of Clauses 15-26, wherein the signaling indicates different target prediction resources associated with different future TD occasions.

Clause 28: The method of any one of Clauses 15-27, wherein the predicted channel characteristics are associated with a single TD occasion in which the UE measures the RSs transmitted on resources of the second set.

Clause 29: An apparatus, comprising: a memory comprising executable instructions; and a processor configured to execute the executable instructions and cause the apparatus to perform a method in accordance with any one of Clauses 1-28.

Clause 30: An apparatus, comprising means for performing a method in accordance with any one of Clauses 1-28.

Clause 31: A non-transitory computer-readable medium comprising executable instructions that, when executed by a processor of an apparatus, cause the apparatus to perform a method in accordance with any one of Clauses 1-28.

Clause 32: A computer program product embodied on a computer-readable storage medium comprising code for performing a method in accordance with any one of Clauses 1-28.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communication at a user equipment (UE), comprising: a memory comprising computer-executable instructions; and one or more processors configured to execute the computer-executable instructions and cause the apparatus to:
receive configuration information configuring the UE with at least one first set of resources for channel prediction and at least one second set of resources for channel measurement, wherein the first and second sets of resources comprise resources associated with different candidate cells;
receive signaling indicating target prediction resources comprising a subset of the first set of resources;
predict channel characteristics associated with one or more time domain (TD) occasions of one or more of the target prediction resources, based on measurement of reference signals (RSs) transmitted on resources of the second set; and
transmit a report indicating the predicted channel characteristics.

2. The apparatus of claim 1, wherein:
the UE supports signaling to switch between the candidate cells via physical (PHY) layer or medium access control (MAC) layer signaling.

3. The apparatus of claim 1, wherein the predicted channel characteristics comprise at least one of physical (PHY) layer reference signal received power (RSRP) or PHY layer signal to interference and noise ratio (SINR).

4. The apparatus of claim 3, wherein the report indicates the predicted channel characteristics for a limited number of resources of the first set, based on ranked values of the PHY layer RSRP or SINR.

5. The apparatus of claim 1 wherein the RSs transmitted on resources of the second set of resources comprise at least one of synchronization signal blocks (SSBs) or channel state information (CSI) RSs.

6. The apparatus of claim 1, wherein:
the first set of resources comprise virtual resources on which reference signals are not transmitted; and
the report includes channel characteristics predicted for virtual resources based on measurement of RSs transmitted on resources of the second set.

7. The apparatus of claim 1, wherein the signaling indicating target prediction resources is received via at least one of radio resource control (RRC) signaling, a medium access control (MAC) control element (CE), or downlink control information (DCI).

8. The apparatus of claim 7, wherein the signaling indicating target prediction resources is received via:
a first type of DCI triggering aperiodic CSI reporting; or
a field in a second type of DCI.

9. The apparatus of claim 7, wherein the signaling indicating target prediction resources is received via a MAC CE that activates semi-persistent (SP) channel state information (CSI) reporting.

10. The apparatus of claim 1, wherein the signaling indicates the target prediction resources using at least one of: one or more cell identifiers (IDs) associated with the target prediction resources, one or more resource set IDs associated with the target prediction resources, or one or more resource IDs associated with the target prediction resources.

11. The apparatus of claim 10, wherein the report indicates:
at least one of the one or more cell IDs or resource set IDs; and
one or more resource IDs associated with the one or more cell IDs or resource set IDs and predicted channel characteristics corresponding to the one or more resource IDs.

12. The apparatus of claim 11, wherein the report is transmitted in at least two parts, including a first part with a fixed payload size and a second part with a flexible payload size determined based on information in the first part.

13. The apparatus of claim 1, wherein the signaling indicates different target prediction resources associated with different future TD occasions.

14. The apparatus of claim 1, wherein predicting channel characteristics associated with one or more TD occasions of one or more of the target prediction resources, based on measurement of RSs transmitted on resources of the second set, comprises:
predicting channel characteristics associated with a single TD occasion in which the UE measures RSs transmitted on resources of the second set.

15. An apparatus for wireless communication at a network entity, comprising: a memory comprising computer-executable instructions; and one or more processors configured to execute the computer-executable instructions and cause the apparatus to:
transmit configuration information configuring a user equipment (UE) with at least one first set of resources for channel prediction and at least one second set of resources for channel measurement, wherein the first and second sets of resources comprise resources associated with different candidate cells;
transmit signaling indicating target prediction resources comprising a subset of the first set of resources;
transmit reference signals (RSs) on resources of the second set; and
receive a report indicating predicted channel characteristics associated with one or more time domain (TD) occasions of one or more of the target prediction resources, based on measurement of the RSs.

16. The apparatus of claim 15, wherein the one or more processors are further configured to execute the computer-executable instructions and cause the apparatus to:
select one of the candidate cells based on the report; and
signal the UE to switch to the selected candidate cell via physical (PHY) layer or medium access control (MAC) layer signaling.

17. The apparatus of claim 16, wherein the predicted channel characteristics comprise at least one of PHY layer reference signal received power (RSRP) or PHY layer signal to interference and noise ratio (SINR).

18-19. (canceled)

20. The apparatus of claim 15, wherein:
the first set of resources comprise virtual resources on which RSs are not transmitted; and
the report includes channel characteristics predicted for virtual resources based on measurement of the RSs transmitted on resources of the second set.

21-23. (canceled)

24. The apparatus of claim 15, wherein the signaling indicates the target prediction resources using at least one of: one or more cell identifiers (IDs) associated with the target prediction resources, one or more resource set IDs associated with the target prediction resources, or one or more resource IDs associated with the target prediction resources.

25-28. (canceled)

29. A method for wireless communication at a user equipment (UE), comprising:
receiving configuration information configuring the UE with at least one first set of resources for channel prediction and at least one second set of resources for channel measurement, wherein the first and second sets of resources comprise resources associated with different candidate cells;
receiving signaling indicating target prediction resources comprising a subset of the first set of resources;
predicting channel characteristics associated with one or more time domain (TD) occasions of one or more of the target prediction resources, based on measurement of reference signals (RSs) transmitted on resources of the second set; and
transmitting a report indicating the predicted channel characteristics.

30. (canceled)
